(19) United States
(12) Patent Application Publication
(10) Pub. No.: US 2010/0060869 A1
(43) Pub. Date: Mar. 11, 2010

(54) LITHOGRAPHIC APPARATUS AND ALIGNMENT METHOD

(75) Inventors: Oleg Viacheslavovich Voznyi, Eindhoven (NL); Johannes Onvlee, 's-Hertogenbosch (NL); Peter Ten Berge, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/553,342

(22) Filed: Sep. 3, 2009

Related U.S. Application Data
(60) Provisional application No. 61/136,470, filed on Sep. 8, 2008.

(51) Int. Cl. G03B 27/52; G03B 27/42

(52) U.S. Cl. 355/30; 355/53

(57) ABSTRACT

An alignment method for a substrate or a patterning device is disclosed along with a corresponding apparatus. The method includes using a part of an alignment arrangement of a lithographic apparatus to undertake a part of an alignment procedure on a part of a substrate or on a part of a patterning device, until the substrate or a part of or in the lithographic apparatus, has become thermally stabilized within a limit.

This application claims priority and benefit under 35 U.S.C. § 119(e) to U.S. Provisional Patent Application No. 61/136,470, entitled “Lithographic Apparatus and Alignment Method”, filed on Sep. 8, 2008. The content of that application is incorporated herein in its entirety by reference.

### FIELD

The present invention relates to a lithographic apparatus and an alignment method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticule, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

When a substrate is loaded onto, for example, a substrate table of a lithographic apparatus, the substrate and substrate table will usually have different initial temperatures. Since the substrate and substrate table have different initial temperatures, a period of time will be required for the substrate and substrate table to reach a thermal equilibrium. In other words, it will take a period of time to reach a point where the substrate and substrate table have become thermally stabilized within, for example, a pre-determined limit. During the time taken for the substrate, for example, to thermally stabilize, the shape and/or size of the substrate may distort as the temperature of the substrate changes.

### SUMMARY

If alignment and exposure of a part of the substrate is undertaken after the substrate has become thermally stabilized, the lithographic apparatus as a whole remains idle for a period of time. While the substrate is or becomes thermally stabilized during this period of time, another part of or in the lithographic apparatus may not be thermally stabilized, for example a part of an alignment arrangement of the lithographic apparatus. This means that when alignment of a part of the substrate is eventually undertaken, inaccurate results may be obtained for another period of time during which the part of the alignment arrangement becomes thermally stabilized.

If, on the other hand, alignment and exposure of a part of a substrate is undertaken before the substrate has become thermally stabilized, a pattern applied to the substrate during the period of thermal stabilization may become distorted due to the thermal distortion of the substrate referred to above. Such distortion can make it difficult to align and overlay patterns applied to the substrate.

While such problems referred to above are applicable to all substrates, the problems may be particularly prevalent in the processing of substrates with a large heat capacity, and/or a low thermal conductivity, and/or a large thermal expansion coefficient, for instance substrates formed from or comprising Al—Ti—C, which is used in the fabrication of thin film (magnetic) heads. While the heat capacity of an Al—Ti—C substrate is similar to that of a more commonly used Si substrate, the thermal conductivity of an Al—Ti—C substrate is much lower than that of an Si substrate. Al—Ti—C substrates used in the fabrication of thin film (magnetic) heads are usually thicker than more commonly used Si substrates. The difference in thermal conductivity of Al—Ti—C and Si, together with the difference in thickness of substrates formed from these materials, means that Al—Ti—C substrates used in the fabrication of thin film (magnetic) heads take longer to thermally stabilize than their Si counter parts.

It is desirable to provide, for example, a lithographic apparatus and an alignment method that obviates or mitigates one or more of the problems identified above or elsewhere.

According to an aspect of the invention, there is provided an alignment method for a substrate or a patterning device, the method comprising using a part of an alignment arrangement of a lithographic apparatus to undertake a part of an alignment procedure on a part of a substrate or on a part of a patterning device, until the substrate or a part of or in the lithographic apparatus has become thermally stabilized within a limit.

The method may further comprise exposing the part of the substrate to radiation in order to apply a pattern to the substrate when it has been determined that the substrate or the part of or in the lithographic apparatus has become thermally stabilized within the limit.

The method may comprise repeating the part of the alignment procedure a certain number of times, the certain number of times being the number of times that the part of the alignment procedure has to be undertaken in order for the substrate or the part of or in the lithographic apparatus to become thermally stabilized within the limit.

The method may comprise aligning the part of the substrate or the part of the patterning device, relative to a part of the lithographic apparatus during a final repetition of the part of the alignment procedure in order to determine information at least indicative of the alignment of the part of the substrate or the part of the patterning device.

The part of the alignment procedure may comprise determining information at least indicative of the alignment of the part of the substrate or the part of the patterning device.

The part of the alignment procedure may comprise aligning the part of the substrate or the part of the patterning device, relative to a part of the lithographic apparatus to determine information at least indicative of the alignment of the part of the substrate or the part of the patterning device.

The method may comprise repeating the part of the alignment procedure until the information at least indicative of the alignment of the part of the substrate or the part of the patterning device, is within the limit, the information being within the limit being at least an indication of the substrate or the part of or in the lithographic apparatus, being thermally stabilized within the limit.

The method may comprise repeating the part of the alignment procedure until a difference between the information obtained on one repetition and the information obtained on another repetition is within the limit, the difference in the information being within the limit being at least an indication of the substrate or the part of or in the lithographic apparatus, being thermally stabilized within the limit.

The information may be related to the translation, symmetric or asymmetric rotation, symmetric or asymmetric expansion, or tilt of the part of the substrate or of the part of the patterning device, or wherein the information is related to an image focus of an image projected onto the part of the substrate or by the part of the patterning device.

The limit of the information, or the limit in the difference in the information, may be an upper and/or lower limit for (values of) the information, and/or a range for (values of) the information. An absolute value for the difference in the information may be within such a limit.

Undertaking a part of an alignment procedure on the part of the substrate or the part of the patterning device, may comprise one or more steps selected from: moving the part of the substrate or the part of the patterning device; illuminating an alignment mark on the part of the substrate or the part of the patterning device; aligning the part of the substrate or the part of the patterning device; performing a dummy alignment of the part of the substrate or the part of the patterning device.

The substrate may comprise Al—Ti—C, GaAs or InP.

The method may be part of a method of fabricating a thin film magnetic head.

The part of or in the lithographic apparatus may be a patterning device.

According to an aspect of the invention, there is provided a lithographic apparatus comprising: a support structure configured to hold a patterning device, the patterning device configured to impart a radiation beam with a pattern in its cross-section; a substrate table configured to hold a substrate; a projection system configured to project the patterned radiation beam onto a target portion of the substrate; an alignment arrangement configured to align a part of the substrate or a part of the patterning device, relative to a part of the lithographic apparatus; and an alignment arrangement controller configured to control a part of the alignment arrangement, the controller configured to control a part of the alignment arrangement in order to undertake a part of an alignment procedure on a part of a substrate or a part of the patterning device, until the substrate or a part of or in the lithographic apparatus, has become thermally stabilized within a limit.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus that may be used to implement an embodiment of the present invention;

FIG. 2 schematically depicts a substrate together with schematic representations of alignment of that substrate;

FIG. 3 schematically depicts a part of an alignment procedure;

FIG. 4 schematically depicts another part of an alignment procedure;

FIG. 5 is a flow chart schematically depicting, in general terms, an alignment method in accordance with an embodiment of the present invention;

FIG. 6 is a flow chart schematically depicting an alignment method in accordance with a further embodiment of the present invention; and

FIG. 7 is a flow chart schematically depicting an alignment method in accordance with a further embodiment of the present invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels, Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

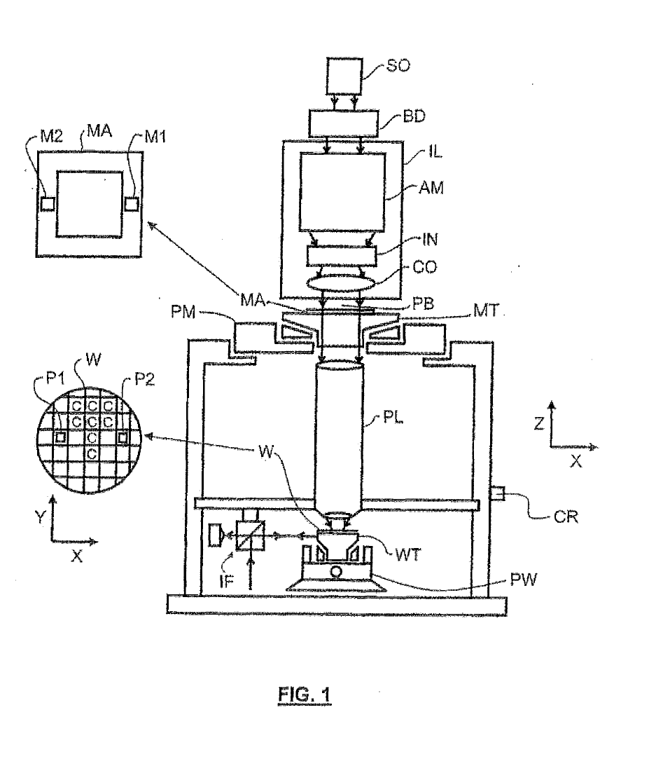

FIG. 1 schematically depicts a lithographic apparatus that can be used to implement an embodiment of the invention. The apparatus comprises:

an illumination system (illuminator) IL to condition a beam PB of radiation (e.g. UV, DUV, EUV or beyond EUV radiation);

a support structure (e.g. a mask table) MT to support a patterning device (e.g. a mask) MA and connected to first positioning device PM to accurately position the patterning device with respect to item PL;

a substrate table (e.g. a wafer table) WT for holding a substrate (e.g. a resist-coated wafer) W and connected to second positioning device PW for accurately positioning the substrate with respect to item PL; and

a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The support structure MT holds the patterning device. It holds the patterning device in a way depending on the orientation of the patterning device, the design of the lithographic apparatus, and other conditions, such as for example whether or not the patterning device is held in a vacuum environment. The support structure MT can use mechanical clamping, vacuum, or other clamping techniques, for example electrostatic clamping under vacuum conditions. The support structure MT may be a frame or a table, for example, which may be fixed or movable as required and which may ensure that the patterning device is at a desired position, for example with respect to the projection system.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The illumination system may also encompass various types of optical components, including refractive, reflective, and catadioptric optical components for directing, shaping, or controlling the beam of radiation, and such components may also be referred to below, collectively or singularly, as a “lens”.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

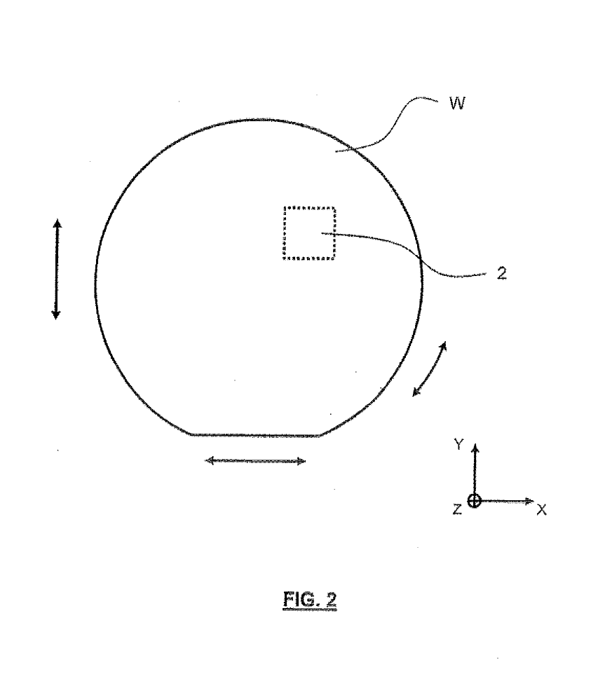

FIG. 2 schematically depicts a plan view of a substrate W (for example the substrate as shown in and described with reference to FIG. 1). An area 2 of the substrate W to be aligned and exposed is also shown. The area 2 may be only one of many of such areas of the substrate W. Before, for example, a pattern is applied to the area 2 on the substrate W the area 2 will need to be aligned relative to a part of the lithographic apparatus. Such alignment is known in the art, and may take the form of global alignment, where alignment properties of all areas of the substrate W are determined before any exposures take place, or die-by-die alignment, where alignment information for each die or area to be exposed is obtained immediately prior to exposure of that area.

Arrows in the Figure show typical rotations or translations of the substrate W that may be undertaken to align the area 2 on the substrate W. For instance, the substrate W may be moved in the x- or y-directions, rotated about the z-axis and/or titled about the x- or y-directions. The configuration of one or more parts of the lithographic apparatus used to apply a pattern to the area 2 (for example the lithographic apparatus shown in and described with reference to FIG. 1) may also or alternatively be changed in order to ensure that a pattern applied to the area 2 of the substrate W is correctly aligned. For example, the configuration of one or more elements of the lithographic apparatus may be changed to take into account a uniform expansion of the substrate W, for example by changing the magnification of a pattern applied to the substrate.

In order to determine information relating to the alignment of the area 2 of the substrate W relative to a part of the lithographic apparatus, a beam of radiation provided by a part of an alignment arrangement may be projected onto one or more alignment marks provided on the substrate W, and/or on the area 2 described above and/or on specific areas on the substrate table WT that are provided with reference alignment marks. Reflection, scattering, diffraction, refraction, interference, etc. of radiation that is incident upon and/or interacts with such alignment marks may be used to obtain information at least indicative of alignment properties of the area 2 of the substrate W, as is known in the art.

In order to align an area 2 of the substrate W with respect to a part of the lithographic apparatus, it will therefore be appreciated that movement of the substrate will be performed, and/or the illumination of one or more alignment marks will be performed. It will be appreciated that each time the substrate is moved, for example by moving a substrate table that holds the substrate, heat from an actuator of the substrate table may be conducted to the substrate. Similarly, when an alignment mark on the substrate is illuminated with a radiation beam, energy present in the radiation beam may provide the substrate with heat energy.

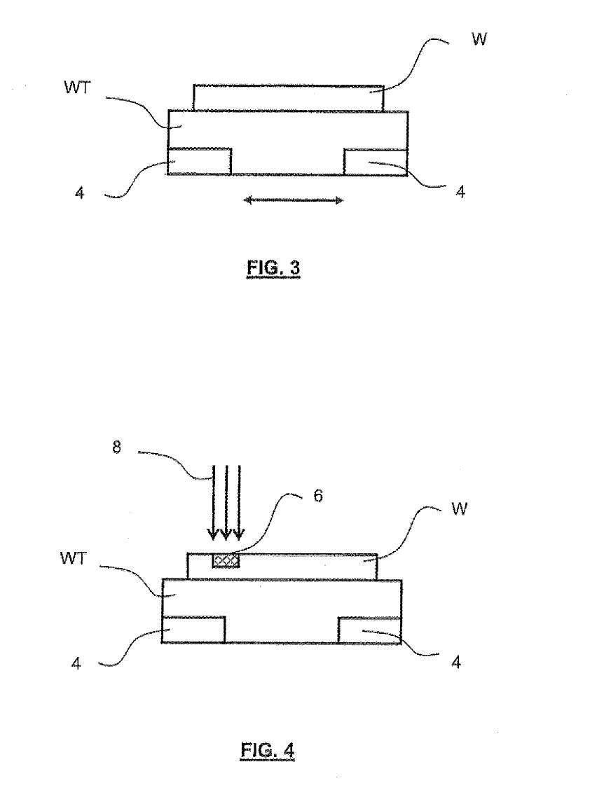

FIGS. 3 and 4 schematically depict two specific examples of how heat (or in other words, thermal energy) may be transferred to the substrate W. FIG. 3 schematically depicts the substrate W held in position by a substrate table WT (for example, the substrate table WT as shown in and described with reference to FIG. 1). The substrate table WT is provided with one or more actuators 4 which may be used to move the substrate table WT, and therefore the substrate W held on the substrate table WT. The actuator 4 forms part of an alignment arrangement, since control of the actuator 4 may be used to align a part of the substrate. The actuator 4 may be part of the positioner PW shown in and described with reference to FIG. 1, be in addition to that positioner PW or be an alternative to that positioner PW. One or more of the actuators 4 may be a linear motor, a stepper motor, or any other suitable actuator. When the actuator 4 is activated to move the substrate table WT, the actuator 4 will generate heat. Heat generated by the actuator 4 may be conducted through the substrate table WT to the substrate W.

FIG. 4 shows the same substrate table WT and substrate W as is shown in FIG. 3. In FIG. 4, the substrate W is shown having an alignment mark 6. A radiation beam 8 is shown as being directed towards the alignment mark 6 in order to determine information related to the alignment mark 6, for example the position of the alignment mark 6 relative to a part of a lithographic apparatus. The radiation beam 8 may be generated using a radiation source of an alignment arrangement (not shown) and detected using another part of the alignment arrangement. When the radiation beam 8 is incident upon the substrate W, it will provide the substrate W with heat.

During operation of a lithographic apparatus, one or more parts (or in other words areas) of a substrate will need to be aligned relative to a part of the lithographic apparatus. Such alignment may be undertaken numerous times, requiring numerous movements of the substrate table and substrate and/or numerous illuminations of alignment marks of the substrate using a radiation beam. Thus, in use, the substrate will become heated due to the alignment process and will, over time, reach a steady state temperature at which point the substrate is thermally stable and is at a typical operating temperature.

As described above, alignment and exposure of a part of a substrate may be undertaken after the substrate has become thermally stabilized. However, when alignment begins, a part of the alignment arrangement (for example, an alignment sensor, an actuator used to move the substrate, etc.) may not be thermally stable. Thus, when the alignment process begins, alignment measurements may initially be inaccurate due to, for example, thermal distortion in one or more parts of the alignment arrangement. Furthermore, as described above, the alignment process itself provides heat to the substrate. Therefore, even though the substrate may initially be at thermal equilibrium with respect to the substrate table that holds the substrate, when the alignment process begins the substrate would then have to reach another thermally stable state (for example, a typical operating temperature) as the alignment process begins.

In accordance with an embodiment of the present invention, the fact that one or more parts of an alignment arrangement will, in use, provide heat to the substrate is taken advantage of. Generally, the aligning and exposing of parts of a substrate are undertaken after the substrate has become thermally stabilized with respect to its surroundings (for example with respect to the substrate table holding the substrate). In contrast, and in accordance with an embodiment of the present invention, a part of the alignment process is used to bring the substrate to a thermally stable state and/or to a typical operating temperature. By doing this, the part of the alignment process also approaches a thermally stable state and/or a typical operating temperature.

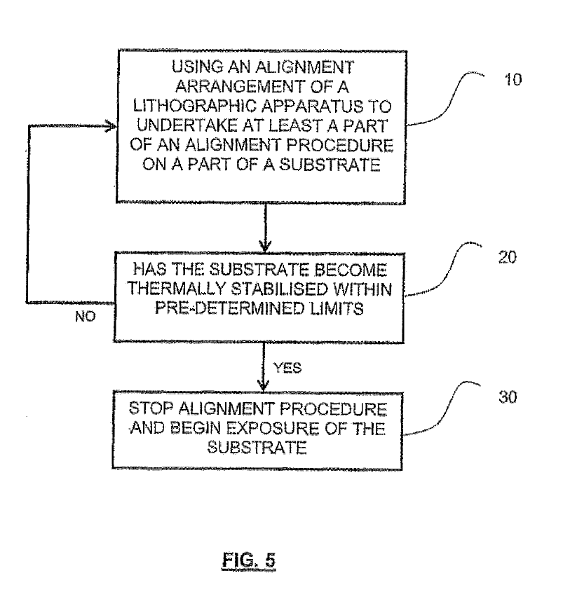

FIG. 5 is a flow chart schematically depicting a general embodiment of the present invention. After a substrate has been loaded into a lithographic apparatus and onto a substrate holder or the like (for example, the substrate table described above), a method according to an embodiment of the present invention may be undertaken. Referring to FIG. 5, at step 10, the method comprising using an alignment arrangement of a lithographic apparatus to undertake a part of an alignment procedure on a part of the substrate. This may comprise: aligning the substrate with respect to a part of the lithographic apparatus, moving the substrate as though it were being aligned, illuminating one or more alignment marks on the substrate as part of an alignment process or undertaking ‘dummy’ alignment processes where the substrate is moved and one or more alignment marks illuminated as if the substrate was being aligned, but no alignment is actually undertaken.

The method further comprises, at step 20, determining if the substrate has become thermally stabilized within a certain limit. Determining whether the substrate has become thermally stabilized may be achieved, for example, by determining the difference in successive measurements of one or more certain properties of the substrate. For example, a property could be the temperature of the substrate measured directly or indirectly, or a property related to the alignment of the substrate, for example: translation, symmetric and asymmetric rotation, symmetric and asymmetric expansion, image focus and/or tilt. The limit may be a range of values, or an upper or lower limit, which corresponds to the property that is being measured, for example a degree of temperature change, or a degree of translation, rotation, expansion, focus and/or tilt. As the substrate thermally stabilizes, the change, or in other words, drift of the property will decrease. The limit may equate, for example, to the difference in the value of a property between subsequent measurements being below a certain value. For example, the limit may be where the change between measurements is less than 10%, less than 5%, less than 1%, or less than 0.1%. The limit may when the measurement is within 80%, or within 90%, or within 95%, or within 99%, or within 99.9%, of the estimated or calculated final value.

If the measurement of the property reveals that the substrate has not become thermally stabilized within the desired limit, step 10 is repeated. Specifically, the alignment arrangement is again used to undertake a part of the alignment procedure on the part of the substrate. After repetition of step 10 again, step 20 is again undertaken. Step 10 and step 20 may be undertaken repeatedly until it is determined that the substrate has become thermally stabilized within the desired limit.

When it is determined that the substrate has become thermally stabilized within the desired limit, at step 30, the alignment procedure is stopped and exposure of the substrate is started. An additional and/or alternative step (not shown in FIG. 5) may be undertaken when it has been determined that the substrate has become thermally stabilized. The additional and/or alternative step may comprise undertaking a full alignment procedure on the part of the substrate onto which a pattern is to be exposed. Of course, if the full alignment procedure (i.e. not merely a part of the alignment procedure) was already being undertaken in step 10 and repeated until the substrate has become thermally stabilized, this additional and/or alternative step may not be required.

The general method according to an embodiment of the present invention that is shown in and described with reference to FIG. 5 is advantageous. For instance, using the method shown in and described with reference to FIG. 5, exposure of part of the substrate will not begin until that substrate is thermally stabilized. This may avoid a problem related to thermal distortion of the substrate during the period when the substrate becomes thermally stabilized. Furthermore, by using a part of the alignment arrangement during the period in which the substrate thermally stabilizes, one or more parts of the alignment arrangement itself may become thermally stabilized, or at least move towards a thermally stabilized state. This means that subsequent alignment of the part of the substrate may be undertaken more accurately, since both the substrate and one or more parts of the alignment arrangement will be (or will be approaching) a thermally stabilized state, thus reducing or minimizing thermal distortion and its associated disadvantages.

One or more controllers of the alignment arrangement may be used to undertake the method described in relation to FIG. 5, and the methods described further below. For instance, one or more alignment arrangement controllers may be used to control a part of the alignment arrangement, for example an actuator used to move the substrate table, or a radiation emitter and/or detector used in determining information related to the configuration of an alignment mark on the substrate. One or more of the controllers may be configured to control a part of the alignment arrangement in order to undertake a part of an alignment procedure on a part of a substrate until a substrate has become thermally stabilized within a desired limit, as described above. The one or more controllers may be a part of the alignment arrangement, or be a separate piece of apparatus. A controller CR of a part of an alignment arrangement is shown in FIG. 1. The location and size of the controller CR is given by way of example only, and the controller CR (and, indeed, one or more of such controllers) may be of any size and may be located in any appropriate location. The controller CR may be, for example, a computer or an embedded processor, or the like, or anything that is capable of controlling a part of an alignment arrangement.

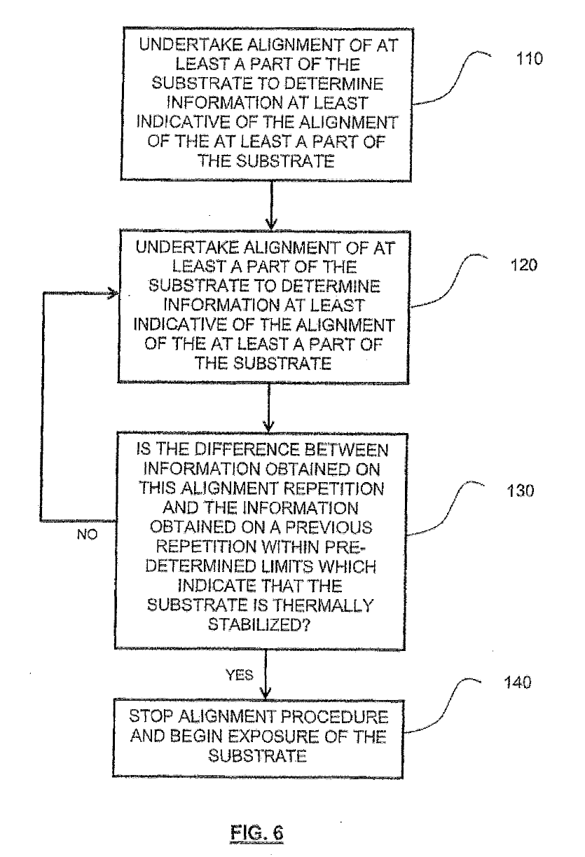

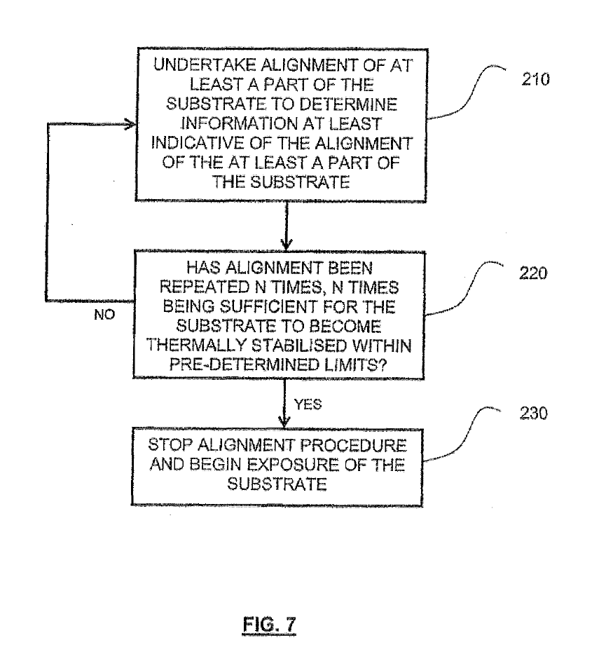

FIG. 5 is a general and schematic depiction of an embodiment of the present invention. In other more specific examples, a part of the substrate may be repeatedly aligned until it is determined that the substrate is thermally stabilized within a desired limit. In another more specific example, an alignment procedure may be undertaken a certain number of times, that certain number of times being known in advance to bring the substrate to a thermally stabilized state within a desired limit. Such specific examples are shown in and described with reference to FIGS. 6 and 7 below.

FIG. 6 is a flow chart schematically depicting an alignment method according to a further, and more specific, embodiment of the present invention. At step 110, the method comprises undertaking alignment of a part of the substrate to determine information at least indicative of the alignment of the part of the substrate. For instance, and as described above, such information may relate to a property such as: translation, symmetric and asymmetric rotation, symmetric and asymmetric expansion, image focus and/or tilt of the part of the substrate. After step 110, undertaking alignment of a part of the substrate to determine information at least indicative of the alignment of the least part of the substrate is undertaken again, like at step 110, at step 120. Step 120 is followed, at step 130, determining if the difference between alignment information obtained on the repetition of the alignment procedure (e.g., at step 120) and the alignment information obtained on a previous repetition of the alignment procedure (e.g. at step 110) is within a limit which indicates that the substrate is thermally stabilized. Step 130 may involve determining whether a change in the value of a measured property between successive measurements is decreasing towards a certain point, or has decreased to that certain point, for example, indicating that the substrate has reached or is reaching a thermally stabilized state. For instance, a difference in the drift of an alignment measurement between successive measurements may be small enough to indicate that the substrate has reached a thermally stabilized state.

If at step 130 it is determined that the difference between the obtained information does not indicate that the substrate is thermally stabilized, then step 120 of the method is undertaken again. The steps 120, 130 are repeatedly undertaken until it is determined that the difference between information obtained on the alignment repetition and the information obtained on a previous alignment repetition is within a limit which indicates that the substrate is thermally stabilized.

If at step 130 it is determined that the difference between information obtained on the alignment repetition and the information obtained on a previous alignment repetition is within a limit which indicates that the substrate is thermally stabilized, step 140 of the method is undertaken. Step 140 comprises stopping the alignment procedure and beginning exposure of the part of the substrate.

The method shown in and described with reference to FIG. 6 has advantages as described with reference to FIG. 5, but also has an added advantage that information regarding the thermal state of the substrate is being actively and repeatedly determined. This helps ensure that the alignment procedure is only undertaken for the number of times that is strictly necessary, thus reducing or eliminating any wasted time associated with unnecessary alignment repetitions. Since alignment information is being obtained (as opposed to just undertaking a part of an alignment procedure, such as moving the substrate or illuminating an alignment mark of the substrate with a radiation beam) it is not necessary to undertake an additional alignment step to obtain alignment information.

In another example, it may be assumed that an indefinite number of repetitions of the alignment procedure is not necessary. This is because it can be determined in advance how many repetitions of a part of the alignment procedure may be required to reach the point where the substrate is thermally stabilized. FIG. 7 shows such an example.

FIG. 7 is a flow chart schematically depicting an alignment method according to a further embodiment of the present invention. At step 210, the method comprises undertaking alignment of a part of the substrate to determine information at least indicative of the alignment of the part of the substrate. Following step 210, at step 220, the method comprises determining whether alignment has been repeated N times, N times being sufficient for the substrate to become thermally stabilized within a limit. If the alignment has not been repeated N times, step 210 of the method is repeatedly undertaken until the alignment has been repeated N times.

If alignment has been repeated N times, step 230 is undertaken, which comprises stopping the alignment procedure and beginning exposure of the substrate.

The number of times (N) for which alignment is undertaken in order to thermally stabilize the substrate may be determined in any of a number of ways. For example, the number of times (N) can be determined using modelling of the substrate and the heating of the substrate due to the alignment procedure. Alternatively or additionally, the number of times (N) can be determined by undertaking the method shown in and described with reference to FIG. 6 and determining at which repetition of the alignment procedure the substrate is considered to be thermally stabilized.

The methods shown in and described with reference to FIGS. 6 and 7 have depicted the repeated alignment of a part of the substrate. However, only one or more, but not all, parts of the alignment procedure may be undertaken in order to provide the substrate with heat and thus be used to thermally stabilize the substrate (and, for example, the one or more parts of the alignment arrangement). For example, as described above, a substrate table used in the alignment process may be moved, without illuminating an alignment mark on the substrate. In another example, one or more alignment marks on the substrate may be illuminated, without moving the substrate. In yet another example, one or more alignment marks may be illuminated and the substrate moved, without actually aligning the substrate (i.e. a dummy alignment may be undertaken). One or more of these parts of an alignment procedure can be undertaken using an alignment arrangement. The alignment arrangement may comprise one or more actuators to move the substrate (for example, by moving a substrate table that holds the substrate), and/or one or more radiation emitters to illuminate an alignment mark on the substrate with a radiation beam, and/or one or more detectors to detect a part of that radiation beam after it has interacted with the alignment mark.

The above embodiments have, in general, been described with reference to the thermal stabilization of the substrate. However, the thermal stabilization of one or more parts of or in the lithographic apparatus may alternatively or in addition be determined. A part of an alignment procedure may be undertaken until this part of or in the lithographic apparatus has become thermally stabilized. The part of or in the lithographic apparatus could be, for example, a part of the patterning device of the lithographic apparatus. The thermal stabilization (or otherwise) of the part of the patterning device may be determined in much the same way as described above in relation to the determination of the thermal stabilization of the substrate. For instance, information may be obtained that is related to the translation, symmetric or asymmetric rotation, symmetric or asymmetric expansion, and/or tilt of the part of the patterning device, or the information may be related to an image focus of an image projected by the part of the patterning device. Such information may be obtained by the illumination of one or more alignment marks located on the patterning device. When the patterning device is thermally stabilized, any pattern imparted by the patterning device into a radiation beam should also be stable, allowing a pattern to be accurately applied to a substrate.

The above embodiments have, in general, been described with reference to the alignment of a substrate. An embodiment of the invention is also or alternatively applicable to the alignment of a part of a patterning device. For example, a part of an alignment procedure may be undertaken on a part of the patterning device in order to help ensure that the substrate, the patterning device, or a part of or in the lithographic apparatus is thermally stabilized. Undertaking a part of an alignment procedure on the part of the patterning device may comprise, for example, one or more of: moving the part of the patterning device; illuminating an alignment mark on the part of the patterning device; aligning the part of the patterning device; performing a dummy alignment of the part of the patterning device.

The above embodiments have been described in relation to the use of Al—Ti—C substrates used in the fabrication of thin film (magnetic) heads. An embodiment of the invention is also or alternatively applicable to a substrate formed from one or more other materials, and to a substrate used in the fabrication of devices other than thin film (magnetic) heads. For example, an embodiment of the invention is applicable to the processing of any substrate with a large heat capacity, and/or a low thermal conductivity, and/or a large thermal expansion coefficient. For example, an embodiment of the invention may be suited to a substrate comprising or formed from Al—Ti—C (having a thermal expansion coefficient of 7.5 ppm/K), GaAs (having a thermal expansion coefficient of 6.9 ppm/K) or InP (having a thermal expansion coefficient of 4.6 ppm/K). This is in contrast with a substrate comprising or formed from a material having a relatively lower thermal expansion coefficient, such as Si (having a thermal expansion coefficient of 2.3 ppm/K) or quartz (having a thermal expansion coefficient of 0.4 ppm/K). An embodiment of the invention is particularly applicable to the fabrication of devices where throughput is not as important as, for example, meeting overlay requirements. This is because the time taken to undertake a part of an alignment procedure to thermally stabilize the substrate, the patterning device or a part of the lithographic apparatus, will be compensated for by the higher degree of accuracy with which a pattern can be applied to, and overlaid on, the substrate.

References herein to a part of an object or method (e.g., of an alignment procedure, or of a substrate, etc.) refers to at least a part of the described object or method. In other words, a part of the described object or method comprises at least a portion of the described object or method and may comprise all of the described object or method. Further, the word “or” is used in the inclusive sense (and/or), unless the context otherwise requires.

While specific embodiments of the invention have been described above, it will be appreciated that the invention may be practiced otherwise than as described. The description is not intended to limit the invention.

1. An alignment method for a substrate or a patterning device, the method comprising: using a part of an alignment arrangement of a lithographic apparatus to undertake a part of an alignment procedure on a part of a substrate or on a part of a patterning device, until the substrate or a part of or in the lithographic apparatus has become thermally stabilized within a limit.

2. The alignment method of claim 1, further comprising exposing the part of the substrate to radiation in order to apply a pattern to the substrate when it has been determined that the substrate or the part of or in the lithographic apparatus has become thermally stabilized within the limit.

3. The alignment method of claim 1, further comprising repeating the part of the alignment procedure a certain number of times, the certain number of times being the number of times that the part of the alignment procedure has to be undertaken in order for the substrate or the part of or in the lithographic apparatus to become thermally stabilized within the limit.

4. The alignment method of claim 3, further comprising aligning the part of the substrate or the part of the patterning device, relative to a part of the lithographic apparatus during a final repetition of the part of the alignment procedure in order to determine information at least indicative of the alignment of the part of the substrate or the part of the patterning device.

5. The alignment method of claim 4, further comprising repeating the part of the alignment procedure until the information at least indicative of the alignment of the part of the substrate or the part of the patterning device, is within the limit, the information being within the limit being at least an indication of the substrate or the part of or in the lithographic apparatus, being thermally stabilized within the limit.

6. The alignment method of claim 5, further comprising repeating the part of the alignment procedure until a difference between the information obtained on one repetition and the information obtained on another repetition is within the limit, the difference in the information being within the limit being at least an indication of the substrate or the part of or in the lithographic apparatus, being thermally stabilized within the limit.

7. The alignment method of claim 4, wherein the information is related to the translation, symmetric or asymmetric rotation, symmetric or asymmetric expansion, or tilt of the part of the substrate or of the part of the patterning device, or wherein the information is related to an image focus of an image projected onto the part of the substrate or by the part of the patterning device.

8. The alignment method of claim 1, wherein undertaking a part of an alignment procedure on the part of the substrate or the part of the patterning device, comprises one or more steps selected from:
moving the part of the substrate or the part of the patterning device;
illuminating an alignment mark on the part of the substrate or the part of the patterning device;
aligning the part of the substrate or the part of the patterning device;
performing a dummy alignment of the part of the substrate or the part of the patterning device.

9. The alignment method of claim 1, wherein the part of the alignment procedure comprises determining information at least indicative of the alignment of the part of the substrate or the part of the patterning device.

10. The alignment method of claim 1, wherein the part of the alignment procedure comprises aligning the part of the substrate or the part of the patterning device, relative to a part of the lithographic apparatus to determine information at least indicative of the alignment of the part of the substrate or the part of the patterning device.

11. The alignment method of claim 1, wherein the part of or in the lithographic apparatus is a patterning device.

12. A lithographic apparatus comprising:
a support structure configured to hold a patterning device, the patterning device configured to impart a radiation beam with a pattern in its cross-section;
a substrate table configured to hold a substrate;
a projection system configured to project the patterned radiation beam onto a target portion of the substrate;
an alignment arrangement configured to align a part of the substrate or a part of the patterning device, relative to a part of the lithographic apparatus; and
an alignment arrangement controller configured to control a part of the alignment arrangement, the controller configured to control a part of the alignment arrangement in order to undertake a part of an alignment procedure on a part of a substrate or a part of the patterning device, until the substrate or a part of or in the lithographic apparatus, has become thermally stabilized within a limit.
